(19) United States
(12) Patent Application Publication
(10) Pub. No.: US 2018/0201880 A1
(43) Pub. Date: Jul. 19, 2018

(54) Cleaning Compositions Comprising at Least One Modified Acrylic Polyamide

(71) Applicant: Colgate-Palmolive Company, New York, NY (US)

(72) Inventors: Luis Javier Rivera Cruz, Mexico City (MX); Jorge Antonio MALDONADO ORTEGA, Delegacion Miguel Hidalgo CP (MX); Edna AMBUNDO, Del. Miguel Hidalgo CP (MX); Victor Omar SERRANO AGUILAR, Coyoacán (MX)

(73) Assignee: Colgate-Palmolive Company, New York, NY (US)

(21) Appl. No.: 15/743,487

(22) PCT Filed: Jul. 10, 2015
(86) PCT No.: PCT/US2015/039935

§ 371 Date: Jan. 10, 2018

(51) Int. Cl. C11D 3/37; C11D 1/90; C11D 3/20; C11D 1/94; C11D 3/22; C11D 11/00

(52) U.S. Cl. CPC C11D 3/3723; C11D 1/90; C11D 3/2068; C11D 1/29; C11D 1/94; C11D 3/222; C11D 11/0035; C11D 3/201

(57) ABSTRACT

Disclosed herein are aqueous cleaning compositions comprising at least one surfactant, at least one modified acrylic polyamide present in the aqueous cleaning composition in an amount ranging from about 0.05% to about 2% by weight of the composition, and dipropylene glycol butyl ether. The cleaning compositions disclosed herein will provide low residue and increased shine and will provide long-lasting, persistent anti-fog properties to a substrate after cleaning. Also disclosed herein are methods of cleaning a substrate comprising applying the aqueous cleaning composition to the substrate and wiping, and the use of at least one surfactant, at least one modified acrylic polyamide, and dipropylene glycol butyl ether in an aqueous cleaning composition to provide shine, low residue, and persistent anti-fog properties to a substrate.

### BACKGROUND

Cleaning compositions are used to clean various substrates. After cleaning, it is desired to minimize any residue left on the substrate and to increase the shine on the substrate. This is particularly important for glass surfaces, which can show any residue. It would therefore be desirable to design a cleaning composition that reduces residue and increases shine.

Moreover, it is a known problem that after showering, surfaces in proximity to the shower, such as the bathroom mirror, may be covered with fog as a result of the condensation of water vapor. Therefore, when a consumer comes out of the shower, the mirror may be unusable for a period of time while the fog evaporates. It would be desirable to have an anti-fog glass spray that would minimize the negative effects of water condensation on a substrate, such as a mirror, so that the mirror would not develop fog, or would develop less fog, and the consumer could use the mirror shortly after showering. For example, it would be desirable if the consumer could see a clear reflection in the mirror shortly after showering without the need to wipe off the mirror first.

Modified acrylic polyamides are known to provide anti-fogging benefits. See, for example, U.S. Published Patent Application No. 2015/0011448, incorporated in its entirety by reference herein. Currently, however, such modified acrylic polyamides only provide an anti-fogging benefit for one fogging cycle, e.g., one shower, after product application. Additionally, there is a limit to the amount of modified acrylic polyamide that can be incorporated into currently known formulations while maintaining a desirable pH because the presence of anionic surfactants are incompatible with higher concentrations of modified acrylic polyamides at a pH below about 5.

It would therefore be desirable to have an anti-fog glass spray that has long-lasting effects over multiple fogging cycles (e.g., showers), such that the consumer would not have to reapply the spray to the substrate before each fog cycle, while maintaining its ability to reduce residue and increase shine.

### BRIEF SUMMARY

Disclosed herein are aqueous cleaning compositions comprising at least one surfactant, at least one modified acrylic polyamide present in the aqueous cleaning composition in an amount ranging from about 0.05% to about 2% by weight of the composition, and dipropylene glycol butyl ether. Also disclosed herein are aqueous cleaning compositions comprising at least two surfactants, at least one modified acrylic polyamide present in the aqueous cleaning composition in an amount ranging from about 0.05% to about 2% by weight of the composition, and dipropylene glycol butyl ether. In certain embodiments, the at least two surfactants may be chosen from amphoteric surfactants, such as cocamidopropyl betaine, and nonionic surfactants, such as alcohol ethoxylates.

In certain embodiments comprising at least one surfactant, the at least one surfactant may be present in the cleaning composition in an amount ranging from about 0.05% to about 2%. In various embodiments of the disclosure comprising at least two surfactants, the at least two surfactants together may be present in the cleaning composition in an amount ranging from about 0.05% to about 2%, such as at least about 0.05% to about 0.5%.

In certain embodiments, the at least one modified acrylic polyamide may be LUPASOL™ PN 60, and in certain embodiments, the at least one modified acrylic polyamide may be present in the cleaning composition in an amount ranging from about 0.05% to about 2%, such as about 0.05% to about 1%, about 0.1% to about 0.5%, or about 0.2% to about 0.3%.

In various embodiments disclosed herein, the dipropylene glycol butyl ether may be present in the cleaning composition in an amount ranging from about 0.1% to about 5%, and in various embodiments, the cleaning composition may further comprise ethanol. In embodiments wherein the cleaning composition comprises ethanol, the ethanol may be present in an amount ranging from about 0.1% to about 5%.

In certain embodiments, the cleaning composition is a glass cleaner. In various embodiments disclosed herein, the composition further comprises an acid, optionally in an amount to provide a pH of about 2 to about 6, such as about 2 to about 5, or about 3 to about 4. In various embodiments, the acid may be lactic acid. In certain exemplary embodiments, the cleaning compositions disclosed herein may further comprise at least one polysaccharide, such as xanthan gum.

Also disclosed herein are aqueous cleaning compositions comprising at least two surfactants comprising cocamidopropyl betaine and alcohol ethoxylate; at least one modified acrylic polyamide present in the aqueous cleaning composition in an amount ranging from about 0.05% to about 2% by weight of the composition; and dipropylene glycol butyl ether. In certain other embodiments disclosed herein, there are aqueous cleaning compositions comprising at least one surfactant comprising sodium lauryl ether sulfate; at least one modified acrylic polyamide present in the aqueous cleaning composition in an amount ranging from about 0.05% to about 2% by weight of the composition; xanthan gum; and dipropylene glycol butyl ether.

Further disclosed herein are methods of cleaning a substrate comprising applying the cleaning composition to the substrate and wiping, wherein in certain embodiments the substrate is glass, such as a mirror. Further disclosed herein is the use of at least one surfactant, at least one modified acrylic polyamide present in the aqueous cleaning composition in an amount ranging from about 0.05% to about 2% by weight of the composition, and dipropylene glycol butyl ether in a cleaning composition to provide shine, low residue, and anti-fog properties to a substrate cleaned with the cleaning composition. In various embodiments of the use disclosed herein, the anti-fog properties remain or persist on the substrate for multiple fog cycles, such as at least about 5 fog cycles, at least about 10 fog cycles, or at least about 15 fog cycles.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a bar graph illustrating the anti-fog performance of a prototype formulation and a comparative formulation over 32 fog cycles.

FIG. 2 is a bar graph illustrating the results of a consumer questionnaire after 4 weeks of usage of a comparative cleaning formulation comprising 0.012% of a modified acrylic polyamide versus a test cleaning formulation comprising 0.26% of a modified acrylic polyamide.

### DETAILED DESCRIPTION

The following description of the preferred embodiments is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

As used herein, the term “one or more of” with respect to a listing of items such as, for example, A and B, means A alone, B alone, or A and B. The term “at least one of” is used to mean one or more of the listed items can be selected.

Unless otherwise specified, all percentages and amounts expressed herein and elsewhere in the specification should be understood to refer to percentages by weight. The amounts given are based on the active weight of the material.

Disclosed herein are aqueous cleaning compositions comprising at least one surfactant, at least one modified acrylic polyamide, and dipropylene glycol butyl ether. While not wishing to be bound by theory, it is believed that the combination of the at least one modified acrylic polyamide and dipropylene glycol butyl ether in the cleaning composition may provide shine, low residue, and anti-fog properties to a substrate.

The cleaning compositions disclosed herein can be used to clean substrates by applying the composition to a substrate and wiping the substrate. In certain embodiments, the cleaning composition is formulated to be a glass cleaner.

The cleaning composition may comprise at least one surfactant. The at least one surfactant can be chosen from any anionic, amphoteric, or zwitterionic surfactants. In certain embodiments, there are at least two surfactants chosen from amphoteric surfactants and nonionic surfactants. In certain embodiments, the amphoteric surfactant may be cocamidopropyl betaine, and in certain embodiments, the nonionic surfactant may be chosen from primary alcohol ethoxylates, such as C9 to C11 alcohols. Exemplary C9 to C11 alcohol ethoxylates may include NEODOL®) 91-8, also known as C9-C11 Pareth 8, a polyethylene glycol ether with an average of 8 moles of ethylene oxide per mole of alcohol. In certain embodiments, the cleaning compositions disclosed herein may comprise at least two surfactants chosen from cocamidopropyl betaine and a primary alcohol ethoxylate, such as NEODOL® 91-8.

In certain embodiments, the at least one surfactant may be an anionic surfactant. As used throughout, wherein the cleaning composition comprises at least one anionic surfactant, the counter ion for the anionic surfactant can be a metal ion, an ammonium ion, or an amine. Metal cations that can be used include, but are not limited to, alkali metal ions and alkaline earth ions. In some embodiments, the metal cation ion can be lithium, sodium, potassium, magnesium, or calcium. In some embodiments, the amine is triethanolamine.

In one embodiment, the at least one surfactant comprises the salt of an alkyl ether sulfate. In one embodiment, the alkyl is a C10 to C14. In one embodiment the surfactant is a sodium lauryl ether sulfate, also known as sodium laureth sulfate. In one embodiment, there is an average of about 1 to about 10 moles of ethylene oxide per mole. In another embodiment, there is an average of about 2 to about 3 moles of ethylene oxide per mole.

In another embodiment, the at least one surfactant comprises a triethanolamine alkyl sulfate. In one embodiment, the alkyl is a C10 to C14 alkyl. In another embodiment the at least one surfactant comprises a triethanolamine lauryl sulfate.

The composition can include an amine oxide surfactant. Amine oxide semi-polar nonionic surfactants can comprise compounds and mixtures of compounds having the formula:

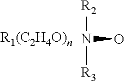

wherein R₁ is an alkyl, 2-hydroxyalkyl, 3-hydroxyalkyl, or 3-alkoxy-2-hydroxypropyl radical in which the alkyl and alkoxy, respectively, contain from 8 to 18 carbon atoms, R₂ and R₃ are each methyl, ethyl, propyl, isopropyl, 2-hydroxyethyl, 2-hydroxypropyl, or 3-hydroxypropyl, and n is from 0 to 10. In certain embodiments, the amine oxides are of the formula:

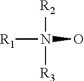

wherein R₁ is a C₁₂₋₁₆ alkyl and R₂ and R₃ are methyl or ethyl. In one embodiment the amine oxides comprise alkyl amine oxides and/or cocoamidopropyl amine oxide. In one embodiment, the ratio of anionic surfactant to amine oxide surfactant is about 3:1 to about 4:1.

In certain embodiments wherein the cleaning composition comprises at least two surfactants, the at least two surfactants together may be present in the cleaning composition in an amount ranging from about 0.05% to about 2%, such as about 0.05% to about 0.5%. In embodiments comprising at least two surfactants, wherein at least one surfactant is chosen from an amphoteric surfactant, the amphoteric surfactant may be present in the cleaning composition in an amount ranging from about 0.05% to about 2%, such as about 0.05% to about 0.5%, by weight of the composition. In embodiments comprising at least two surfactants, wherein at least one surfactant is chosen from a nonionic surfactant, the nonionic surfactant may be present in the cleaning composition in an amount ranging from about 0.05% to about 2%, such as about 0.05% to about 0.5%, by weight of the composition.

In certain embodiments wherein the cleaning composition comprises at least one surfactant, the at least one surfactant may be present in the cleaning composition in an amount ranging from about 0.05% to about 2%, such as about 0.05% to about 0.5%, by weight of the composition.

In certain embodiments disclosed herein, the cleaning composition comprises at least one modified acrylic polyamide, such as an amphoteric polyamine. A non-limiting example of an amphoteric polyamine is a multifunctional cationic polyethyleneimine, such as LUPASOL™ PN 60 from BASF, formerly known as SOKALAN™ HP70. In certain embodiments, the amphoteric polyamine can be present in an amount ranging from about 0.05% to about 2% by weight of the composition, such as about 0.05% to about 1%, about 0.1% to about 0.5%, or about 0.2% to about 0.3%, by weight of the composition. The percentages by weight of the at least one modified acrylic polyamide are reported herein as active material and not as the raw material of the product as incorporated into the composition.

Cationic polyethyleneimines such as LUPASOL™ PN 60 are modified acrylic polyamides having a highly-branched amine structure having the general molecular formula —(CH₂—CH₂—NH)ₙ—, wherein 10<n<10⁵. In certain embodiments, the at least one modified acrylic polyamide disclosed herein may be a cationic polyethyleneimine having a nitrogen to carbon ratio of 1:2. In certain embodiments, the at least one modified acrylic polyamide may be represented by the following formula:

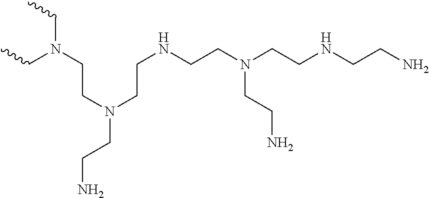

In certain embodiments, the cleaning composition further comprises dipropylene glycol butyl ether (also known as dipropylene glycol n-butyl ether or DPnB). In certain embodiments, the dipropylene glycol butyl ether can be present in an amount ranging from about 0.1% to about 5% by weight of the composition, such as from about 0.1% to about 2%, by weight of the composition.

The cleaning composition may further comprise at least one additional solvent. Because water and dipropylene glycol n-butyl ether may already be included in the cleaning composition disclosed herein, the term solvent, as used herein, refers to solvents in addition to these two materials. Examples of solvents include, but are not limited to alkylene glycols, glycol ethers, propylene glycol, propylene glycol n-butyl ether, propylene glycol n-propyl ether, ethylene glycol n-hexal ether, ethylene glycol n-butyl ether, dipropylene glycol methyl ether, C₁ to C₆ alkyl alcohols, methanol, ethanol, n-propanol, isopropanol, n-butyl alcohol, sec-butyl alcohol, isobutyl alcohol, tert-butyl alcohol, 1-2- or 3-pentanol, neopentyl alcohol, hexanol, and combinations thereof. The at least one solvent can be present in any amount. In certain embodiments, the at least one solvent is present in an amount ranging from about 0.1% to about 10% by weight of the composition. In other embodiments, the amount of the at least one solvent ranges from about 0.1% to about 5%, by weight of the composition.

In certain embodiments, the cleaning composition disclosed herein may comprise at least two solvents chosen from dipropylene glycol n-butyl ether and ethanol. In embodiments comprising at least two solvents, the at least two solvents together may be present in the cleaning composition in an amount ranging from about 0.1% to about 10%, such about 0.1% to about 5%.

In certain embodiments disclosed herein, the cleaning composition is substantially free of propylene glycol. As used herein, the term “substantially free of” means about 0% by weight or an amount that is so low as to not have a reasonable chemical effect on the formulation.

In certain embodiments the cleaning compositions disclosed herein are aqueous compositions. The amount of water can be any amount. The compositions can be supplied as ready-to-use compositions. In certain embodiments, the amount of water can be greater than 90% by weight of the composition, such as greater than 91%, greater than 92%, greater than 93%, or greater than 94% by weight of the composition. In certain embodiments, the amount of water is about 95% by weight of the composition or greater than about 95% by weight of the composition, such as greater than about 96%, greater than about 97%, or ranging from about 90% to about 98%.

The cleaning composition can also be supplied as a concentrate that can later be diluted with water. The composition can be at least 2, at least 3, at least 4, or at least 5 times concentrated from the above ready to use concentration, in which case, the amounts of materials are adjusted accordingly.

The cleaning composition can be formulated to any pH. In certain embodiments, the cleaning composition further comprises ammonia or ammonium hydroxide. In certain embodiments, the ammonia or ammonium hydroxide can be present in an amount that provides a pH of about 9 to about 12, such as, for example, a pH of about 10 to about 12.

In certain embodiments, the cleaning composition further comprises at least one acid. Examples of acids include, but are not limited to, organic acids, inorganic acids, lactic acid, formic acid, citric acid, sorbic acid, acetic acid, glycolic acid, propanoic acid, propionic acid, oxalic acid, maleic acid, tartaric acid, adipic acid, malic acid, malonic acid, glycolic acid, and combinations thereof. In certain embodiments, the at least one acid can be present in an amount that provides a pH of 2 to 6, such as, for example, a pH of 2 to 5.

In certain exemplary embodiments, the cleaning compositions disclosed herein may further comprise at least one polysaccharide, such as xanthan gum. The xanthan gum may be present in the cleaning composition in an amount ranging from about 0% to about 1%, such as about 0.05% to about 1%, or about 0.15% to about 0.5%. While not wishing to be bound by theory, it is hypothesized that the at least one polysaccharide such as xanthan gum may form hydrogen bonds with the at least one modified acrylic polyamide, allowing the polymer to be anchored in place and resulting in enhanced anti-fog properties of the cleaning compositions disclosed herein.

The cleaning composition may optionally comprise any other additives that are used in cleaning compositions, such as colorants, fragrances, pro-fragrances, preservatives, rheology modifiers, structuring agents, hydrotropes, whitening agents, reducing agents, enzymes, enzyme stabilizing agents, builders, bleaches, photobleaches, bleach catalysts, soil release agents, dye transfer inhibitors, buffers, soil repellents, water-resistance agents, suspending agents, aesthetic agents, and combinations thereof. An exemplary preservative may include isothiazolinone. These materials can be used in any desired amount.

In certain embodiments, the cleaning composition disclosed herein may comprise the following exemplary ingredients, in addition to other ingredients listed herein and as known in the art:

| Ingredient | Amount (w/w) |
|---|---|
| Water | >95% |
| Dipropylene glycol butyl ether | 0.1%-2% |
| Ethanol | 0.1%-2% |
| Modified polyamide | 0.05%-1% |
| NEODOL ® 91-8 | 0.05%-0.5% |
| Cocamidopropyl betaine | 0.05%-0.5% |

In certain embodiments, the cleaning composition disclosed herein may comprise the following exemplary ingredients, in addition to other ingredients listed herein and as known in the art:

| Ingredient | Amount (w/w) |
|---|---|
| Water | >95% |
| Dipropylene glycol butyl ether | 0.1%-2% |
| Ethanol | 0.1%-2% |
| Modified polyamide | 0.05%-1% |
| Xanthan gum | 0.1%-1% |
| Sodium lauryl ether sulfate | 0.05%-0.5% |

Also disclosed herein are methods of using a cleaning composition comprising at least one surfactant, such as at least two surfactants, at least one modified acrylic polyamide, and dipropylene glycol butyl ether, said method comprising applying the cleaning composition to a substrate, such as a glass surface, and wiping the substrate. In certain embodiments, the glass surface is a mirror. According to certain methods disclosed herein, applying the cleaning composition to the substrate may result in or produce an anti-fog effect on the substrate. As used herein, an anti-fog effect refers to an effect that prevents or substantially reduces water condensation on the surface of a substrate, such a mirror, compared to the water condensation under the same conditions on an untreated substrate. Examples of an anti-fog effect include an effect that allows an even, thin water layer to form on the substrate such that there is a clear image and/or a good reflection from the surface of the substrate despite the even, thin water layer. In certain embodiments, the anti-fog effect may last, remain, or persist for multiple fog cycles without reapplication, such as at least about 2 fog cycles, at least about 5 fog cycles, at least about 10 fog cycles, at least about 15 fog cycles, or at least about 20 fog cycles. As used herein, a fog cycle refers to the process of steam forming a water condensate on a hard surface or substrate and then evaporating. In certain embodiments, a fog cycle may comprise a shower, wherein steam from the hot water of the shower forms a condensate on the surface of a substrate, such as a mirror.

### EXAMPLES

### Example 1

Several prototype formulations were prepared containing different levels of the modified acrylic polyamide LUPASOL™ PN 60. Additionally, a comparative formulation was prepared that comprised a lower concentration (i.e., 0.03%) of LUPASOL™ PN 60, as well as a different surfactant and solvent mixture. Table 1 below details the ingredients in the comparative formulation and the prototype formulations that were used for the anti-fog evaluation described herein.

TABLE 1

| | Comparative | Prototype |
|---|---|---|
| Ingredient | formulation | formulation |
| Sodium lauryl ether sulfate | 0.15% | |
| Cocamidopropyl betaine and C9-C11 | | 0.35% |
| Alcohol 8EO | | |
| Solvent mixture (Propylene glycol | <5% | |
| n-butyl ether, polypropylene glycol, | | |
| and ethanol) | | |
| Solvent mixture (dipropylene glycol | | <5% |
| n-butyl ether and ethanol) | | |
| LUPASOL ™ PN 60 | 0.03% | 0.4%-0.9% |
| Color | <0.01% | <0.01% |
| Preservative | <0.1% | <0.1% |
| Water | QS | QS |
| pH (Acidic, resulting from the | 3-4 | 3-4 |
| addition of an organic or | | |
| inorganic acid compound to get | | |
| the pH in range, e.g., lactic | | |
| acid, citric acid, acetic acid, | | |
| phosphoric acid, hydrochloric | | |
| acid, etc.) | | |

Specifically, five prototype formulations were prepared, having an amount of LUPASOL™ PN 60 of 0.4%, 0.65%, and 0.9%, and an amount of lactic acid of 0.035%, 0.5% and 0.65%. Each of the five prototype formulations underwent an anti-fog evaluation for at least 20 fog cycles. Table 2 below details the composition of the five prototype formulations prepared, as well as the number of fog cycles for which each formulation received a good performance evaluation.

TABLE 2

| | | | | # Anti-Fog |
|---|---|---|---|---|
| | | | | cycles rated |
| | % LUPASOL ™ | % Lactic | | Good |
| Formulation | PN 60 | acid | pH | Performance |
| Prototype 1 | 0.90 (0.36 active) | 0.05 | 3.74 | 17 |
| Prototype 2 | 0.65 (0.26 active) | 0.065 | 3.47 | 20 |
| Prototype 3 | 0.65 (0.26 active) | 0.05 | 3.62 | 20 |
| Prototype 4 | 0.40 (0.16 active) | 0.05 | 3.58 | 0 |
| Prototype 5 | 0.65 (0.26 active) | 0.035 | 3.80 | 0 |
| Comparative | 0.03 (0.012 active) | 0.05 | 3.5 | 1 |

An anti-fog evaluation was conducted for the prototypes using a fog cycle methodology that included a steam generator and a sink (e.g., a stainless steel washbasin) to simulate a bathroom shower cycle, such as a 10 minute shower in a consumer's home. The results were expressed based on an evaluation scale of no performance, medium performance, and good performance. A fog cycle was rated no performance if there was fog on the surface of the substrate (a mirror), and a reflection could not be perceived. A fog cycle was rated medium performance if a thin water film was visible on the surface of the mirror, and a reflection could be perceived, although it was distorted. A fog cycle was rated good performance if there was a clear image in the mirror and the reflection could be perceived.

For the fog cycle methodology, in order to simulate a 10-minute shower, mirrors that had been sprayed with the formulation to be tested were introduced into a sink, and the sink was covered. Steam was applied for an amount of time ranging from about 10 seconds to about 1 minute, and the steam was sealed in the sink for several seconds. Then a comparison was made between the amounts of water vapor that had condensed or accumulated on the surfaces of the mirrors. This process constituted one fog cycle. In order to evaluate the longevity of a formulation, multiple fog cycles were run and evaluated for good performance, medium performance, or no performance.

As shown above in Table 2, the inclusion of the modified acrylic polyamide at levels from 0.4% to 0.9% with a nonionic/amphoteric surfactant and solvent mixture comprising dipropylene glycol butyl ether and ethanol provided a longer-lasting, more persistent anti-fog performance. The comparative formulation only provided a good performance for one fog cycle.

### Example 2

Prototype formulations were prepared and compared to a comparative formulation in order to evaluate the prototypes' cleaning ability, consumer preferences, and anti-fog longevity or persistence on mirror and glass surfaces. Table 3 below details ingredients included in both the prototype formulations and the comparative formulation.

TABLE 3

| | Compar- | Prototype | Prototype | Prototype |
|---|---|---|---|---|
| | ative | #1 | #2 | #3 |
| | Formu- | Formu- | Formu- | Formu- |
| Ingredient | lation | lation | lation | lation |
| LUPASOL ™ | 0.03% | .25% | .20% | 0.65% |
| PN 60 | (0.012% | (0.1% | (0.08% | (0.26% |
| | active) | active) | active) | active) |
| Sodium lauryl | 0.15% | 0.15% | 0.15% | — |
| ether sulfate | | | | |
| Cocamidopropyl | — | — | — | 0.35% |
| betaine and | | | | |
| NEODOL ® 91-8 | | | | |
| Solvent mixture | — | 4% | 3.75% | 2% |
| (dipropylene | | | | |
| glycol n-butyl | | | | |
| ether and | | | | |
| ethanol) | | | | |
| Xanthan gum | — | — | 0.15% | — |
| Solvent mixture | 4.5% | — | — | — |
| (propylene glycol | | | | |
| n-butyl ether, | | | | |
| propylene glycol, | | | | |
| and ethanol) | | | | |

### Part A:

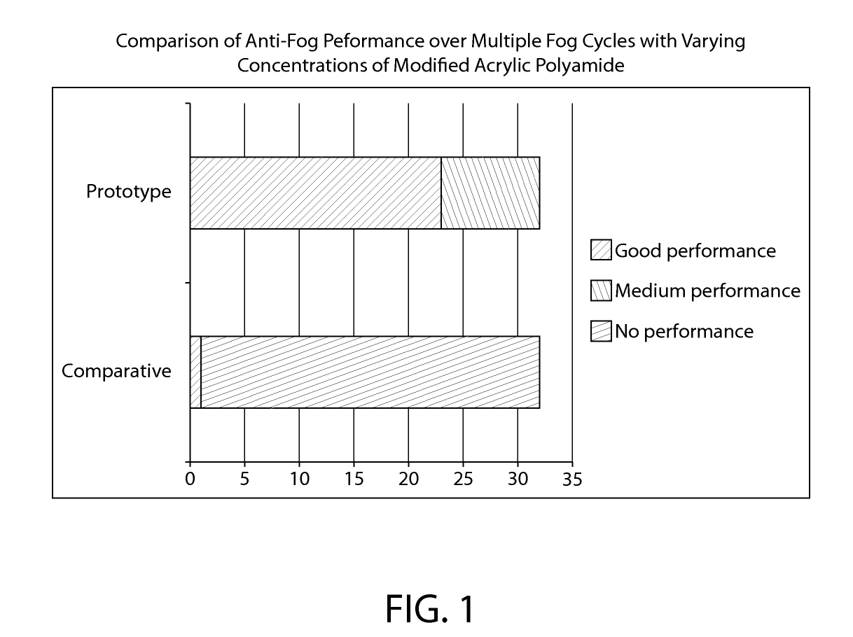

The comparative and Prototype #3 formulation underwent 32 anti-fog evaluation testing cycles, as described above in Example 1. The Prototype #3 formulation received a good performance rating for 23 cycles, and a medium performance rating for the following 9 cycles. The comparative formulation received a good performance rating for the first cycle, and no performance rating for the following 31 cycles. FIG. 1 illustrates the results and shows the long-lasting, persistent effects of the prototype formulation as compared to the comparative formulation over multiple anti-fog cycles.

### Part B:

Sixty consumers were asked to test the prototype cleaning formulations and the comparative formulation at home for four weeks and keep usage diaries. Consumers were provided questionnaires after week 1 and week 4 to evaluate the formulations. Table 3 above details the ingredients in the prototype formulations and the comparative formulation.

A mirror was divided into a left section and a right section using adhesive tape, and the consumer was asked to apply a prototype formulation to the one section and the comparative formulation to the remaining section.

For the prototype #1 formulation, after 4 weeks of product usage, a statistically significant percentage of consumers were overall more satisfied with the performance of the prototype #1 formulation over the comparative formulation and felt prototype #1 was clearer/more transparent. Consumers also felt the prototype was better than their usual glass cleaner, smelled fresh, dried faster, and was the right texture (e.g., not too runny). Table 4 below shows the results of the consumer questionnaire after 4 weeks of product usage for prototype #1.

TABLE 4

| | Comparative | Prototype #1 | |
|---|---|---|---|
| | Formula | Formula | |
| Question asked of | (0.012% | (0.08% | |
| consumer | polyamine) | polyamine) | |
| Overall, more satisfied | 24% | 45%* | 24% (both) |
| The area is cleaner | 44% | 56% | |
| with . . . | | | |
| Easier to clean while | 48% | 52% | |
| wiping | | | |
| Clearer/more | 40% | 60%* | |
| transparent | | | |
| No fog | 44% | 56% | |
| No streaks | 48% | 52% | |
| No residues | 44% | 56% | |
| The area I cleaned is | 47% | 53% | |
| brighter with | | | |
| Better than my usual | 40% | 60%* | |
| glass cleaner | | | |
| Smells more fresh | 37% | 63%* | |
| Need to clean less | 47% | 53% | |
| often | | | |
| Dry faster | 42% | 58%* | |
| Right texture; not too | 37% | 63%* | |
| runny | | | |
| Recommend to my | 47% | 53% | |
| relatives or friends | | | |

*Significantly superior at 80% confidence interval two-tailed test

For the prototype #2 formulation, after 4 weeks of product usage, a statistically significant percentage of consumers were overall more satisfied with the performance of the comparative formulation over the prototype formulation. Table 5 below shows the results of the consumer questionnaire after 4 weeks of product usage.

TABLE 5

| | Comparative | Prototype #2 | |
|---|---|---|---|
| | Formula | Formula | |
| Question asked of | (0.012% | (0.08% | |
| consumer | polyamine) | polyamine) | |
| Overall, more satisfied | 49%* | 29% | 21% (both) |
| The area is cleaner | 56% | 44% | |
| with . . . | | | |
| Easier to clean while | 67%* | 33% | |
| wiping | | | |
| Clearer/more | 62%* | 38% | |
| transparent | | | |
| No fog | 49% | 51% | |
| No streaks | 62%* | 38% | |
| No residues | 62%* | 38% | |
| The area I cleaned is | 60%* | 40% | |
| brighter with | | | |
| Better than my usual | 65%* | 35% | |
| glass cleaner | | | |
| Smells more fresh | 49% | 51% | |
| Need to clean less | 59%* | 41% | |
| often | | | |
| Dry faster | 57% | 43% | |
| Right texture; not too | 56% | 44% | |
| runny | | | |
| Recommend to my | 60%* | 40% | |
| relatives or friends | | | |

*Significantly superior at 80% confidence interval two-tailed test

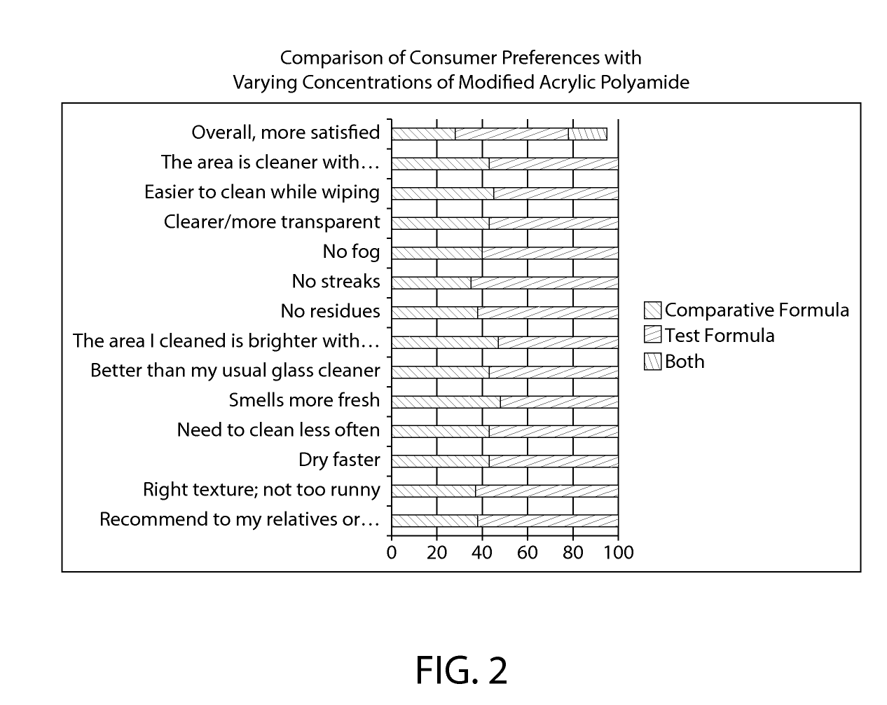

For the prototype #3 formulation, after 4 weeks of product usage, a statistically significant percentage of consumers were overall more satisfied with the performance of the prototype #3 formulation over the comparative formulation and felt the prototype left less fog, streaks, or residues on the mirror. A majority of the consumers also felt the prototype was a desirable texture (e.g., not too runny) and would recommend the prototype to others. The results of the consumer questionnaire after 4 weeks are shown in FIG. 2, and illustrate the prototype's superiority over the comparative formulation. Table 6 below shows the results of the consumer questionnaire after 4 weeks of product usage.

TABLE 6

| | Comparative | Prototype #3 | |
|---|---|---|---|
| | Formula | Formula | |
| Question asked of | (0.012% | (0.26% | |
| consumer | polyamine) | polyamine) | |
| Overall, more satisfied | 28% | 50%* | 17% (both) |
| The area is cleaner | 43% | 57% | |
| with . . . | | | |
| Easier to clean while | 45% | 55% | |
| wiping | | | |
| Clearer/more | 43% | 57% | |
| transparent | | | |
| No fog | 40% | 60%* | |
| No streaks | 35% | 65%* | |
| No residues | 38% | 62%* | |
| The area I cleaned is | 47% | 53% | |
| brighter with | | | |
| Better than my usual | 43% | 57% | |
| glass cleaner | | | |
| Smells more fresh | 48% | 52% | |
| Need to clean less | 43% | 57% | |
| often | | | |
| Dry faster | 43% | 57% | |
| Right texture; not too | 37% | 63%* | |
| runny | | | |
| Recommend to my | 38% | 62%* | |
| relatives or friends | | | |

*Significantly superior at 80% confidence interval two-tailed test

It was therefore shown that after cleaning with the prototype formulations, an extended or long-lasting anti-fogging benefit as well as other benefits were provided on glass surfaces such as mirrors.

### Example 3

Several prototype formulations were prepared containing different levels of the modified acrylic polyamide LUPASOL™ PN 60 and 0.15% of xanthan gum. Additionally, a comparative formulation was prepared that comprised a lower concentration (i.e., 0.03%) of LUPASOL™ PN 60 and no xanthan gum. Table 7 below details the ingredients in the comparative formulation and the prototype formulations that were used for the anti-fog evaluation described herein (below).

TABLE 7

| | | Prototype | Prototype | Prototype | Prototype | Prototype | Prototype |
|---|---|---|---|---|---|---|---|
| Ingredient | Comparative | #1 | #2 | #3 | #4 | #5 | #6 |
| Sodium lauryl ether | 0.15% | 0.15% | 0.15% | 0.15% | 0.15% | 0.15% | 0.15% |
| sulfate | | | | | | | |
| Solvent mixture | — | <5.00% | <5.00% | <5.00% | <5.00% | <5.00% | <5.00% |
| (dipropylene glycol | | | | | | | |
| n-butyl ether and | | | | | | | |
| ethanol) | | | | | | | |
| Solvent mixture | <5.00% | — | — | — | — | — | — |
| (propylene glycol | | | | | | | |
| n-butyl ether, | | | | | | | |
| propylene glycol, | | | | | | | |
| and ethanol) | | | | | | | |
| LUPASOL ™ PN 60 | 0.03% | 0.05% | 0.10% | 0.15% | 0.20% | 0.23% | 0.30% |
| Xanthan gum | — | 0.15% | 0.15% | 0.15% | 0.15% | 0.15% | 0.15% |
| Color | <0.01% | <0.01% | <0.01% | <0.01% | <0.01% | <0.01% | <0.01% |
| Preservative | <0.1% | <0.1% | <0.1% | <0.1% | <0.1% | <0.1% | <0.1% |
| Water | Q.S. to | Q.S. to | Q.S. to | Q.S. to | Q.S. to | Q.S. to | Q.S. to |
| | 100% | 100% | 100% | 100% | 100% | 100% | 100% |

Additionally, several prototype formulations were prepared containing different levels of the modified acrylic polyamide LUPASOL™ PN 60 and not comprising xanthan gum. Table 8 below details the ingredients in the prototype formulations that were used for the anti-fog evaluation described herein (below).

TABLE 8

| | Prototype | Prototype | Prototype | Prototype | Prototype | Prototype |
|---|---|---|---|---|---|---|
| Ingredient | #7 | #8 | #9 | #10 | #11 | #12 |
| Sodium lauryl ether | 0.15%) | 0.15% | 0.15% | 0.15%) | 0.15% | 0.15% |
| sulfate | | | | | | |
| Solvent mixture | <5.00% | <5.00% | <5.00% | <5.00% | <5.00% | <5.00% |
| (dipropylene glycol | | | | | | |
| n-butyl ether and | | | | | | |
| ethanol) | | | | | | |
| Solvent mixture | — | — | — | — | — | — |
| (propylene glycol | | | | | | |
| n-butyl ether, | | | | | | |
| propylene glycol, | | | | | | |
| and ethanol) | | | | | | |
| LUPASOL ™ PN 60 | 0.05% | 0.10% | 0.15% | 0.20% | 0.23% | 0.30% |
| Xanthan gum | — | — | — | — | — | — |
| Color | <0.01% | <0.01% | <0.01% | <0.01% | <0.01% | <0.01% |
| Preservative | <0.1% | <0.1% | <0.1% | <0.1% | <0.1% | <0.1% |
| Water | Q.S. to | Q.S. to | Q.S. to | Q.S. to | Q.S. to | Q.S. to |
| | 100% | 100% | 100% | 100% | 100% | 100% |

The formulations prepared as described in Tables 7 and 8 both with and without xanthan gum were subjected to the anti-fogging evaluation disclosed above in Example 1. Namely, according to the fog cycle methodology, in order to simulate a 10-minute shower, mirrors that had been sprayed with the formulation to be tested were introduced into a sink, and the sink was covered. Steam was applied for an amount of time ranging from about 10 seconds to about 1 minute, and the steam was sealed in the sink for several seconds. Then a comparison was made between the amounts of water vapor that had condensed or accumulated on the surfaces of the mirrors. This process constituted one fog cycle. In order to evaluate the longevity of a formulation, multiple fog cycles were run and evaluated for good performance, medium performance, or no performance. Table 9 below details the results of the maximum number of good performance anti-fog cycles achieved with each of the prototype formulations prepared.

TABLE 9

| | LUPASOL ™ | Xanthan | Maximum # good |
|---|---|---|---|
| | PN 60 | gum | performance |
| Formulation | (% w/w) | (% w/w) | anti-fog cycles |
| Prototype #1 | 0.05 | 0 | 1 |
| Prototype #2 | 0.10 | 0 | 4 |
| Prototype #3 | 0.15 | 0 | 5 |
| Prototype #4 | 0.20 | 0 | 7 |
| Prototype #5 | 0.23 | 0 | 17 |
| Prototype #6 | 0.30 | 0 | 18 |
| Prototype #7 | 0.05 | 0.15 | 20 |
| Prototype #8 | 0.10 | 0.15 | 21 |
| Prototype #9 | 0.15 | 0.15 | 22 |
| Prototype #10 | 0.20 | 0.15 | 24 |
| Prototype #11 | 0.23 | 0.15 | 24 |
| Prototype #12 | 0.30 | 0.15 | 25 |

The data indicate that the inclusion of xanthan gum provided the aqueous cleaning compositions disclosed herein with an increased anti-fog performance, even when the levels of the modified acrylic polyamide are low.

What is claimed is:

1. An aqueous cleaning composition comprising:
a) at least one surfactant;
b) at least one modified acrylic polyamide present in the aqueous cleaning composition in an amount ranging from about 0.05% to about 2% by weight of the composition; and
c) dipropylene glycol butyl ether.

2. The aqueous cleaning composition of claim 1, wherein the at least one surfactant comprises at least two surfactants chosen from amphoteric surfactants and nonionic surfactants.

3. The aqueous cleaning composition of claim 2, wherein the amphoteric surfactant is cocamidopropyl betaine.

4. The aqueous cleaning composition of claim 2, wherein the nonionic surfactant is chosen from alcohol ethoxylates.

5. The aqueous cleaning composition of claim 2, wherein the at least two surfactants are present in an amount ranging from about 0.05% to about 2%.

6. The aqueous cleaning composition of claim 2, wherein the at least two surfactants are present in an amount ranging from about 0.05% to about 0.5%.

7. The aqueous cleaning composition according to claim 1, further comprising xanthan gum.

8. The aqueous cleaning composition according to claim 7, wherein the at least one surfactant is sodium lauryl ether sulfate.

9. The aqueous cleaning composition according to claim 1, wherein the at least one modified acrylic polyamide is LUPASOL™ PN 60.

10. The aqueous cleaning composition according to claim 1, wherein the at least one modified acrylic polyamide is present in the aqueous cleaning composition in an amount ranging from about 0.05% to about 1%.

11. The aqueous cleaning composition according to claim 1, wherein the at least one modified acrylic polyamide is present in the aqueous cleaning composition in an amount ranging from about 0.1% to about 0.5%.

12. The aqueous cleaning composition according to claim 1, wherein the dipropylene glycol butyl ether is present in an amount ranging from about 0.1% to about 5%.

13. The aqueous cleaning composition according to claim 1, further comprising ethanol.

14. The aqueous cleaning composition according to claim 13, wherein the ethanol is present in amount ranging from about 0.05% to about 2%.

15. The aqueous cleaning composition according to claim 1, wherein the aqueous cleaning composition is a glass cleaner.

16. The aqueous cleaning composition of claim 1, wherein the aqueous cleaning composition further comprises an acid in an amount to provide a pH of about 2 to about 6.

17. The aqueous cleaning composition of claim 1, further comprising lactic acid.

18. A method of cleaning a substrate, the method comprising: applying the aqueous cleaning composition of claim 1 to the substrate; and wiping the aqueous cleaning composition across the substrate.

19. (canceled)

20. (canceled)

21. (canceled)

22. An aqueous cleaning composition comprising:
a) at least two surfactants comprising cocamidopropyl betaine and alcohol ethoxylate;
b) at least one modified acrylic polyamide present in the aqueous cleaning composition in an amount ranging from about 0.05% to about 2% by weight of the composition; and
c) dipropylene glycol butyl ether.

23. An aqueous cleaning composition comprising:
a) at least one surfactant comprising sodium lauryl ether sulfate;
b) at least one modified acrylic polyamide present in the aqueous cleaning composition in an amount ranging from about 0.05% to about 2% by weight of the composition;
c) xanthan gum; and
d) dipropylene glycol butyl ether.
